(19) United States
(12) Patent Application Publication
(10) Pub. No.: US 2010/0229473 A1
(43) Pub. Date: Sep. 16, 2010

(54) Pneumatic Tower Design

(75) Inventors: Dennis Simpson, Belleville, MI (US); Christopher Crain, Belleville, MI (US)

Correspondence Address: HARNESS, DICKEY & PIERCE, P.L.C., P.O. BOX 828, BLOOMFIELD HILLS, MI, 48303, US

(73) Assignee: Thomas Industrial Rolls, Inc., Dearborn, MI (US)

(21) Appl. No.: 12/402,064

(22) Filed: Mar. 11, 2009

(51) Int. Cl. E04H 12/18; B23P 11/00

(52) U.S. Cl. 52/111; 29/428

(57) ABSTRACT

A telescopic support tower has a plurality of tubes nested or stacked with one another. A base is coupled with the outermost tube to stand the plurality of tubes transverse to the base. A mechanism is provided in the base to enable access to an interior space of the plurality of tubes. The mechanism is coupled with a source of compressed air. A plurality of seals, at least two, are positioned on each of the adjacent tubes to seal the tubes with respect to one another. The plurality of seals enables sealed sliding movements of the tubes with respect to one another. At least one first clamp is provided to prohibit movement of selected tubes of the plurality of tubes such that only one tube of the plurality of tubes is enabled to telescope at a time. At least one second clamp fixes the selected telescoping tube to an adjacent tube of the plurality of tubes.

### FIELD

The present disclosure relates to towers and, more particularly, to turbine towers that are raised pneumatically.

### BACKGROUND

Currently in the United States, and specifically the Midwest, a zone of minimal wind energy is available at approximately 40 feet above the earth surface. The payback on an investment in a wind energy system designed and installed at the 40 feet level is approximately 10 to 15 years. Most of these towers are mono-pole or guided lattice work towers. They involve the preassembly of the entire tower length along with the turbine and lifting the entire assembly with a crane. The space requirements are proportional to the entire tower height or the crane size required to lift the tower and turbine. Additionally, maintenance on the turbine often requires the same size crane to return to the tower in order to remove the turbine for maintenance work. Alternatively, the tower could be climbed or if possible a basket crane may raise a workman in order to do maintenance work on the tower.

Accordingly, it is desirable to have a tower design that eliminates the necessity of a large crane in order to raise the tower, while providing a tower that extends to the 80-120 foot wind zones. The present disclosure provides the art with a tower design that eliminates the need to raise the tower with a large crane. The present disclosure provides a device that extends the turbine into the 80-120 foot wind zones where higher mile per hour winds are available. The present device provides a telescoping tower that can be easily tilted up by a small crane or a gin pole and tractor or truck. The present device provides a tower that can be raised by compressed air from readily available portable compressors.

### SUMMARY

According to one aspect of the disclosure, a telescoping turbine support tower comprises a plurality tubes stacked or nested one within another with one tube defining an outermost tube. A base is coupled with the outermost tube. The base enables standing of the plurality of tubes transverse to horizontal. A mechanism is in the base that provides a conduit into an interior space of the plurality of tubes. The mechanism is coupled with a source of compressed air. A plurality of seals is provided. At least two seals are positioned on each tube to seal adjacent tubes with respect to one another. The plurality of seals enables sliding movement of the tubes with respect to one another. At least one first clamp fixably clamps adjacent tubes with one another to prohibit movement of selected tubes of the plurality of tubes such that only a first tube of the plurality of tubes is capable of telescoping at a time. At least one second clamp is fixed to the first selected telescoping tube adjacent a next tube of the plurality of tubes. The first selected tube of the plurality of tubes includes a cap at one end. A guide clamp with a plurality of ears, each including an aperture to receive a guide line, is secured to a tube. The at least one first clamp defines a first inner diameter portion sized to be positioned around an outer diameter of a first tube to enable telescoping movement of the first tube. A second diameter portion is sized to prohibit telescoping movement of an adjacent next tube. The tubes include end caps to mate in the first and second diameter portions. At least one second clamp is positioned an end cap when the first telescoping tube is in a raised position. The end caps have an outer contour to mate with a corresponding inner contour on the at least one clamp. The end caps have an annular portion acting as a stop to contact one of the seals to position the first tube with respect to an adjacent next tube in a telescope position. The plurality of the tubes may include any number of tubes having a desired length to raise the turbine to the desired 80-120 feet zone.

According to a second aspect of the disclosure, a method is provided to raise a wind turbine tower comprises providing a plurality of nested telescoping tubes in a vertical position with respect to the earth. An outermost tube is secured with a base to be anchored on a pad. The plurality of tubes is clamped together with one another such that only one tube at a time can be telescopically raised with respect to the outermost tube. A turbine is connected to a first innermost tube. Compressed air is injected into the plurality of tubes to raise the first innermost tube. The first innermost tube is fixed with a second next adjacent tube. The second next adjacent tube is unclamped to enable telescoping movement of the second next tube with respect to a third next tube. Compressed air is injected into the plurality of tubes to raise the first and second next innermost tube. The second next innermost tube is fixed to the third next adjacent tube. The injecting of air step and fixing step are repeated until all of the plurality of tubes is raised with respect to the outermost tube. The plurality of tubes is sealed with respect to one another to enable sealed telescopic movement of the tubes with respect to one another. End caps are provided on the tubes to enhance fixing of adjacent tubes of the plurality of tubes. The outermost tube is secured with a base and the base is leveled with respect to the plurality of tubes.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a telescoping tower with a wind turbine.

FIG. 2 is an elevation view of the base of the telescoping tubes.

FIG. 3 is an enlarged perspective view of the base of the telescoping tubes.

FIG. 4a is an elevation view of the nested telescoping tube.

FIG. 4b is an enlarged partially cross-section view of the tops of the nesting tubes.

FIG. 5 is an elevation view of a raised tube with respect to the remainder of the plurality of tubes.

FIG. 6a is a cross-section view of FIG. 5 along 6-6 thereof.

FIG. 6b is a cross-section view of a first clamp.

FIG. 6c is a cross-section view of an end cap.

FIG. 7a is a cross-section view of a split clamp.

FIG. 7b is a perspective view of a split clamp.

### DETAILED DESCRIPTION

Example embodiments will now be described more fully with reference to the accompanying drawings.

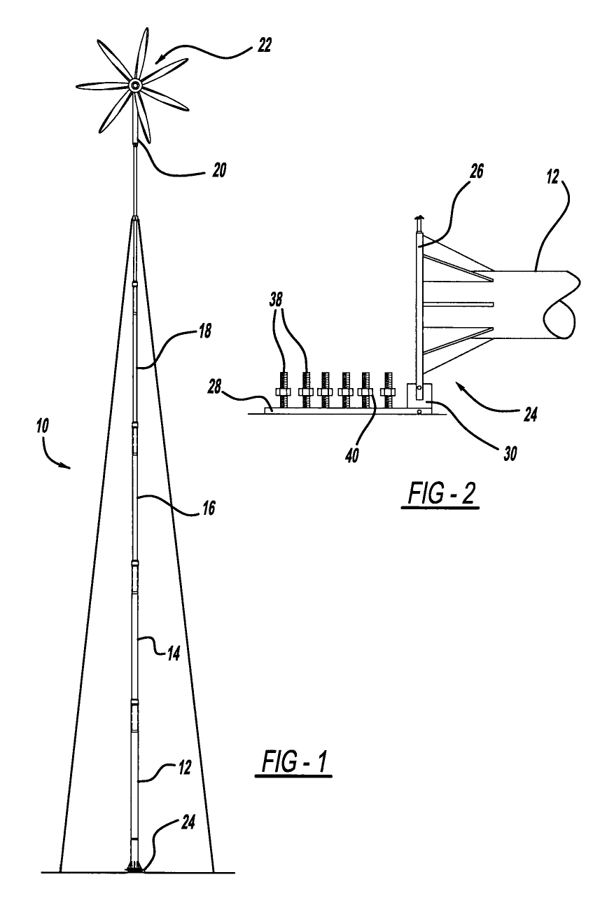

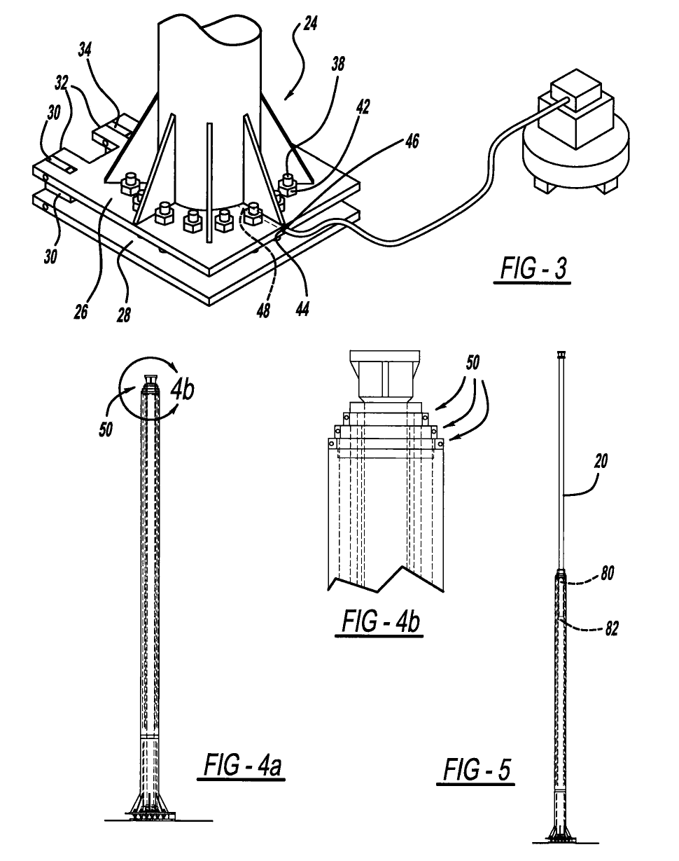

Turing the Figures, particularly FIG. 1, a tower is illustrated with the reference numeral 10. The tower includes a plurality of tubes 12-20. Also, a turbine 22 is positioned at the top of the innermost tube 20. The tubes 12-20 telescope and nest with respect to one another as illustrated in FIGS. 1 and 2. The tubes are generally manufactured from a metallic material and have a desired diameter depending upon the final desired height of the turbine. In the present embodiment, the tubes 12-20 are over 20 feet long and approximately 24 feet long and have outer diameters from 4 inch to 11.5 inch. However, any number of tubes having a desired height with desired diameter can be used to raise the turbine to the 80-120 feet zone. Thus, a larger number of short tubes may be used. The outermost tube 12 is secured with a pivoting base 24.

The base 24 includes a first plate 26 and a second plate 28. The first plate 26 is connected to the second plate 28 via blocks 30. The blocks 30 project from the second plate 28. The first plate 26 includes a plurality of fingers 32 with slots 34 to receive the blocks 30. A pivot pin 36 is passed through the fingers 32 and the block 30 to pivotally connect the first plate 26 with the second plate 28 via the block 30. The second plate 28 includes a plurality of projecting threaded bolt portions 38. The second plate 28 is secured into a concrete pad structure, or the like on the ground to provide securement of the plurality of telescoping tubes 12-20 with the ground. The bolts 38 include a plurality of nuts 40 that are positioned underneath the first plate 26. The nuts 40 are adjustable to level the first plate 26. Additionally, bolts 42 are secured on top of the plate 26 to secure the plurality of tubes in a vertical position as shown in FIG. 1.

The first plate 26 includes an air passageway or conduit 44 bored into the first plate 26. It has one end 46 that is connected to an air compressor or the like 44, by conventional means. The other end 48 opens into the interior of the plurality of tubes 12-20. Thus, as will be explained later, compressed air is injected into the interior of the plurality of tubes 12-20 to raise the telescoping tubes with respect to one another.

Turning to FIG. 4, the tops of the tubes 12-20 are illustrated. As can be seen, a plurality of first tube clamps 50 is shown. The tube clamps 50 secure with the end caps 52 secured onto the plurality of tubes by welding the like. The end caps 52 have an annular ring portion 54 with an integral extending cylindrical ring portion 56. A groove 58 is formed on the outer circumference of the cylindrical portion 56. Thus, the groove 58 defines a pair of outer flanges 60 and 62. The flanges 60, 62 are secured to the tube clamps 50 as explained herein.

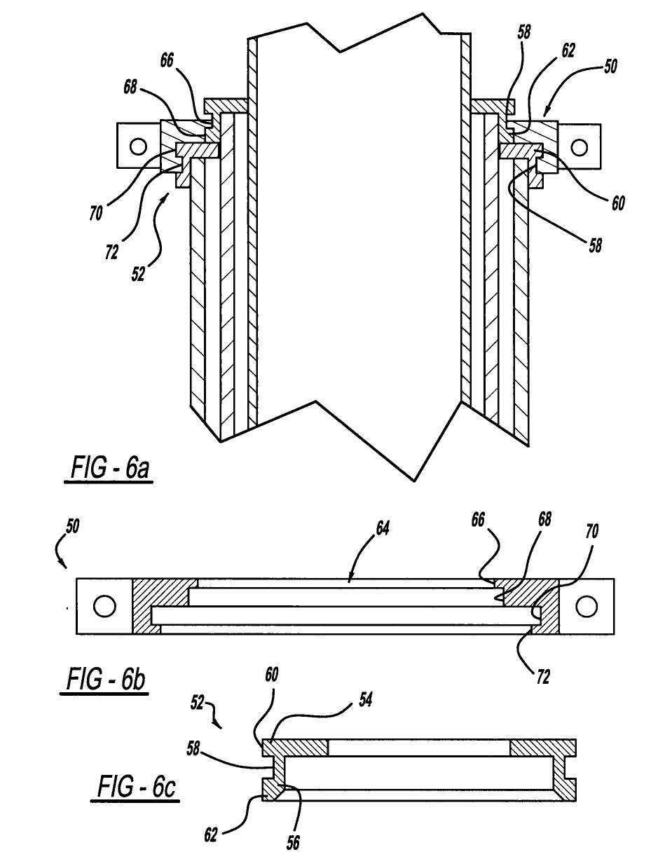

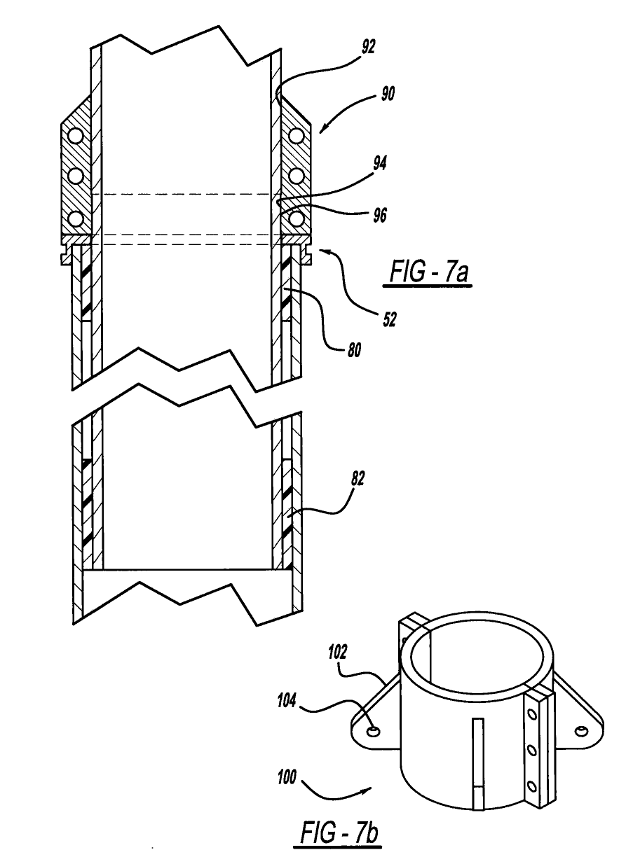

The tube clamps 50 include two identical clam shell parts that are connected together by bolts or the like. The tube clamps 50, when both parts are connected with one another form an annular configuration. The tube clamp inner surface 64 defines a first cylindrical wall portion 66 sized to fit in to the groove 58 of the end cap 52 (as shown in FIGS. 6a, 6b). A second cylindrical portion 68 defines a larger diameter than that of the first cylindrical portion 66. The second cylindrical portion 68 receives the flange 62 of the end cap 52. The third cylindrical portion 70 defines a larger diameter wall than the second cylindrical portion 68. The third cylindrical portion 70 receives the flange portion 60 of the adjacent end cap 52. The fourth cylindrical portion 72 extends into the groove 58 of the adjacent end cap 52. As can be seen, the tube clamps 50 fix adjacent tubes 12-20 with respect to one another 12-20. This enables only the first innermost tube 20 to be moved at one time. It expands and telescopes the first innermost tube 20 upward with respect to the remainder 12-18 of the plurality of tubes.

Turning to FIG. 5, the first innermost tube 20 is telescoped upward. It is moved until a first seal 80 contacts the end cap 52 as illustrated. Also, a second seal 82 is positioned toward the end of the tube inside of the plurality of tubes 12-20. The seals 80, 82 act as pistons to enable movement of the first innermost tube 20 with respect to the fixed remainder of plurality of tubes 12-18. As the air is injected into the tubes 12-20, the seals 80, 82 provide a sliding air tight seal with respect to adjacent tubes to prohibit the air from exiting the plurality of tubes 12-20 to raise the plurality of tubes. After the first tube 20 is raised, a split clamp 90 is positioned about the first tube 20. The split clamp 90 rests upon the end cap 52.

The split clamp 90 includes a central bore 92 that defines the inner surface of the clamp 90. The bore includes an undercut portion 94 having a diameter smaller than the first central bore portion 92. The undercut diameter portion 94 is positioned onto an undercut portion 96 in the first tube 20. Thus, the split clamp 90 can be connected and bolted onto the first tube 20. The split clamp 90 rests on the end cap 52 and the weight of the tube, as well as, the turbine prohibits the tube from extending out of the adjacent tube 18.

A guide clamp 100 may be positioned onto the first tube 20. The guide clamp 100 includes a plurality of ears 102 with apertures 104 to receive guidelines. The guidelines enhance the securement and balance of the tower with respect to the ground, but are not necessarily required.

In raising the telescopic tubes 12-20, compressed air is injected through the base plate conduit into the plurality of tubes 12-20. Since the plurality of tubes 12-20 are secured together via the first tube clamps 50 with respect to one another only the first innermost tube 20 is capable of telescoping out of the remainder 12-18 of the plurality of tubes. After the first innermost tube 20 has been raised, a split clamp 90 is attached to the first innermost tube 20 and secured by bolts. After this occurs, compressed air is again injected into the base plate conduit 44. Prior to this, the next tube clamp 50 is taken off of the second next adjacent tube 18. This enables the second innermost tube 18 to be raised with the first innermost tube 20. After these are raised into position with the seal 80 contacting the end cap 52, a split clamp 90 is positioned onto the second tube 18 with respect to adjacent tubes 12-16. This process continues until all of the remaining tubes 16, 14 are raised with respect to the outermost tube 12. After this occurs, the tower is in a position to be utilized for the generation of electrical power.

In order to conduct maintenance or the like on the turbine, compressed air can be injected into the plurality of tubes in a raised position. The split clamp 90 on the lowermost tubes 14, 12 is removed. The compressed air is released from inside the tubes. This enables a slow downward telescoping movement of the tube 14 inside the outermost tube 12. After the tube 14 reaches its original position, a first tube clamp 50 is placed onto the tube to fix the inner tube 14 with respect to the outermost tube 12. This process continues until all of the tubes are nested inside one another. At that time, maintenance can be conducted on the turbine 22.

Also, electrical wires and the like can be positioned outside the tubes and moved up with each raising of the tubes of the tower. Thus, the tower enables the turbine 22 to reach the 80-120 foot wind zone where it is capable of experiencing increased wind speeds. This enables the turbine to produce more energy and enable a quicker return on investment.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A telescoping support tower comprising:
a plurality of tubes stacked one within another surrounded by an outermost tube;
a base coupled with said outermost tube, said base for standing said plurality of said tubes transverse to horizontal;
a mechanism in said base providing a conduit into an interior space of said plurality of tubes, said mechanism for coupling with a source of compressed air;
a plurality of seals, at least two positioned on each tube for sealing adjacent tubes with one another, said plurality of seals enabling sliding movement of said plurality of tubes with respect to one another;
at least one first clamp, said first clamp prohibiting movement of selected tubes of said plurality of tubes such that only one tube of said plurality of tube is capable of telescoping at a time; and
at least one second clamp, said second clamp fixing said one selected telescoping tube adjacent a tube of said plurality of tubes.

2. The telescoping support tower of claim 1, wherein a first innermost tube of said plurality of tubes includes a cap at one end.

3. The telescoping support tower of claim 1, wherein said at least one first clamp defines a first inner diameter portion sized for position around an outer diameter of a tube for prohibiting telescoping movement of an outer tube and a second diameter portion sized to enable telescoping movement of an adjacent inner tube.

4. The telescoping support tower of claim 3, wherein said tubes include end caps for mating in said first and second diameter portions.

5. The telescoping support tower of claim 1, wherein said tubes include end caps for mating with first end caps.

6. The telescoping support tower of claim 5, wherein said at least one second clamp is positioned adjacent an end cap.

7. The telescoping support tower of claim 3, wherein said end caps have an out contour for mating with a corresponding inner contour on said at least one first clamp.

8. The telescoping support tower of claim 5, wherein said end cap having an annular portion acting as a stop for contacting one of said seals for positioning one tube with respect to an adjacent tube in an extended position.

9. The telescoping support tower of claim 1, wherein said plurality of tubes includes a desired number of tubes, each tube having a desired length so that upon telescoping, the plurality of tubes extend the tip of the innermost tube to an 80-120 feet zone.

10. A method of raising a wind turbine comprising:
providing a plurality of nested telescoping tubes in a vertical position with respect to earth;
securing an outermost tube with a base anchored in the earth;
clamping said plurality of tubes together with one another such that only one tube at a time can be telescopingly raised with respect to the outermost tube;
connecting a turbine to a first innermost tube;
injecting compressed air into said plurality of tubes for raising said first innermost tube;
fixing said first innermost tube with a next adjacent tube.

11. The method of claim 10, further comprising unclamping a second innermost tube for enabling telescoping movement with respect to said outermost tube;
injecting compressed air into said plurality of tubes to raise said first and second innermost tubes;
fixing said second innermost tube to a third adjacent tube; and
repeating the injecting step and fixing steps until all of the plurality of tubes are raised with respect to the outermost tube.

12. The method of claim 10, further comprising sealing said plurality of tubes with respect to one another for enabling sealed telescoping movement of said tubes.

13. The method of claim 10, further comprising providing end caps on said tubes for enhancing fixing of adjacent tubes of said plurality of tubes.

14. The method of claim 10, further comprising securing said outermost tube with a base and leveling said base with said plurality of tubes.
